(19) United States
(12) Patent Application Publication
(10) Pub. No.: US 2025/0252362 A1
(43) Pub. Date: Aug. 7, 2025

(54) ENERGY MANAGEMENT SYSTEM FOR OPTIMIZING ENERGY CONSUMPTION OF A FACILITY

(71) Applicant: GlacierGrid Inc., San Francisco, CA (US)

(72) Inventors: Donald Lloyd Watts, Mountain View, CA (US); Manik Varun Suri, San Francisco, CA (US); Chander Chawla, Palo Alto, CA (US)

(21) Appl. No.: 19/047,542

(22) Filed: Feb. 6, 2025

Related U.S. Application Data
(60) Provisional application No. 63/550,051, filed on Feb. 6, 2024.

(51) Int. Cl. G06Q 10/04; G06Q 10/0631; G06Q 50/06; H02J 3/00

(52) U.S. Cl. CPC G06Q 10/04; G06Q 10/0631; G06Q 50/06; H02J 3/003; H02J 3/007; H02J 2203/20; H02J 2310/14

(57) ABSTRACT

An energy management system monitors and controls equipment in a facility to optimize energy consumption of the facility. The system optimizes the energy consumption subject to constraints associated with each equipment, while minimizing a cost metric. The system monitors equipment of the facility by receiving sensor data generated by sensors of the equipments of the facility. The system determines values of control signals for controlling the equipments of the facility. The system generates control signals to operate each equipment within one or more constraints. The values of the control signals are determined to optimize an energy consumption metric for the facility. For each equipment, the system sends control signals having a value determined for the equipment to control the equipment.

### CROSS-REFERENCE TO RELATED APPLICATION

This application claims the benefit of U.S. Provisional Application No. 63/550,051, filed on Feb. 6, 2024, which is incorporated by reference in its entirety.

### FIELD OF INVENTION

The disclosure relates to management of energy consumed by equipment in a facility in general and more specifically to an intelligent energy management system for optimizing energy consumption of a facility with equipment that consumes energy.

### BACKGROUND

Several facilities such as industries, restaurants, workshops, and so on maintain equipment that consumes energy, for example, refrigeration equipment, heating equipment, air conditioning equipment, or HVAC (heating, ventilation, and air conditioning) equipment. The equipment may control temperature, pressure, humidity, and so on. The energy consumption by such equipment may have significant impact on maintenance of the facility. Certain facilities have time periods during which the usage of equipments is high, for example, the number of equipments that are active during such periods can be high and each equipment may be used at a high capacity. For example, during daytime a facility may have to use equipment that generates heat, for example, for cooking or for industrial use and also use air conditioning equipment for cooling areas where people are operating. Such peak use by multiple facilities may put huge stress on the power grid of an area.

### SUMMARY

A system, for example, an energy management system monitors and controls equipment in a facility to optimize energy consumption of the facility. The system optimizes the energy consumption of the facility subject to constraints associated with each equipment, while minimizing an energy consumption metric, for example, a cost metric.

According to an embodiment, the system monitors equipment of the facility. The facility comprises equipments such as refrigeration equipment, air conditioning equipment, heating equipment, and so on for adjusting temperature within the facility. The system monitors equipment of the facility by receiving sensor data generated by sensors of the equipments of the facility. The system determines values of control signals for controlling the equipments of the facility.

The system generates control signals to operate each equipment within one or more constraints. The values of the control signals are further determined to optimize an energy consumption metric for the facility. For each equipment, the system sends control signals having values determined for the equipment to control the equipment. The control signals cause the equipment to operate within the one or more constraints associated with the equipment. The system determines a value of the energy consumption metric for the facility and sends the value to a user associated with the facility.

According to an embodiment, an equipment of the facility is a refrigeration equipment, wherein the constraints of the equipment require the temperature inside the refrigeration equipment to be maintained within a range.

According to an embodiment, an equipment of the facility is an air conditioning equipment, wherein the constraints of the air conditioning equipment require the temperature of a room of the facility cooled by the air conditioning equipment to be maintained within a range. The constraints of the air conditioning equipment may require the humidity of the room of the facility to be maintained within a range.

According to an embodiment, an equipment of the facility is a heating equipment, wherein the constraints of the heating equipment require a temperature of a room of the facility heated by the air conditioning equipment to be maintained within a range.

According to an embodiment, determining the values of the control signals to optimize an energy consumption metric for the facility comprises, predicting a time of peak energy consumption of the facility and reducing energy consumed by one or more equipments at the time predicted for peak energy consumption of the facility. For example, the system may reduce energy consumed by an equipment by shutting off the equipment for a time interval during which the time predicted for peak energy consumption of the facility occurs.

According to an embodiment, the equipment is an air conditioner and reducing the energy consumed by the air conditioner comprises raising the temperature of a room cooled by the air conditioner to a higher value permitted by a constraint associated with the air conditioner.

According to an embodiment, the equipment is a refrigeration equipment and reducing the energy consumed by the equipment comprises raising the temperature of the refrigeration equipment to a higher value permitted by a constraint associated with the refrigeration equipment.

According to an embodiment, the equipment is a heating equipment and reducing energy consumed by the heating equipment comprises reducing the temperature of a room heated by the heating equipment to a lower value permitted by a constraint associated with the heating equipment.

Embodiments of the invention include methods described herein, a non-transitory computer readable storage medium storing instructions that cause one or more computer processors to perform steps of the methods disclosed herein. Embodiments of the invention include systems comprising one or more computer processors and computer readable non-transitory storage medium that cause the one or more computer processors to perform steps of the methods disclosed herein.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 shows an overall system environment in which an energy management system operates, according to an embodiment.

FIG. 2 illustrates the architecture of the energy management system in the context of the system environment, according to an embodiment.

FIG. 3 is a flowchart illustrating the overall process of the energy management system, according to an embodiment.

FIG. 4 illustrates the architecture of a savings estimator component of the energy management system, according to an embodiment.

FIG. 5 illustrates the computation of savings in energy consumption, according to an embodiment.

FIG. 6 illustrates a peak shaving system that determines the control signals for controlling energy consumption of a facility, according to an embodiment.

FIG. 7 illustrates how peak shaving of energy consumption improves the cost metrics of energy consumption, according to an embodiment.

FIG. 8 is a block diagram illustrating components of an example machine able to read instructions from a machine-readable medium and execute them in a processor (or controller).

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### DETAILED DESCRIPTION

Embodiments allow intelligent management of energy consumption of equipment for facilities thereby saving on energy consumption as well as cost of maintaining the equipment for the facility. An energy management system controls the energy consumption of a facility to reduce the overall energy consumption and cost. Furthermore, the energy management system helps control temperature, thereby improving the user experience of people in the facilities as well as provide improvements such as reducing food wastage by preventing failures of refrigeration equipment or as a result of reducing the temperature of refrigeration equipment to a level below the specified level.

The energy management system 110 disclosed can reduce energy consumption metrics by as much as 10% by optimizing the usage and timing of electrical power. The energy management system 110 monitors the health of the refrigeration equipment to protect against food spoilage, warn of equipment failures, and reduce CO2 emissions. The energy management system 110 sends carefully timed control signals to the freezer, cooler, and HVAC systems, turning them off and on at precisely the right times to have the best effect on reducing the power consumption of the restaurant as a whole and reducing its monthly bill. The energy management system 110 uses temperature sensors to monitor the freezer, cooler, and interior air temperature to ensure food safety and restaurant comfort. The energy management system 110 uses power sensors to monitor the power consumption of the freezer, cooler, and HVAC system to ensure that we produce the best possible savings for the restaurant owner. It's a sophisticated real-time control system built to optimize savings while preserving food safety. These processes are all conducted seamlessly for a facility, for example, a restaurant without affecting their operations. Additionally, the energy management system 110 uses the industry standard IPMVP (International Performance Measurement and Verification Protocol) protocol to reliably measure savings. This way, enterprises can be confident that they are getting the best possible results.

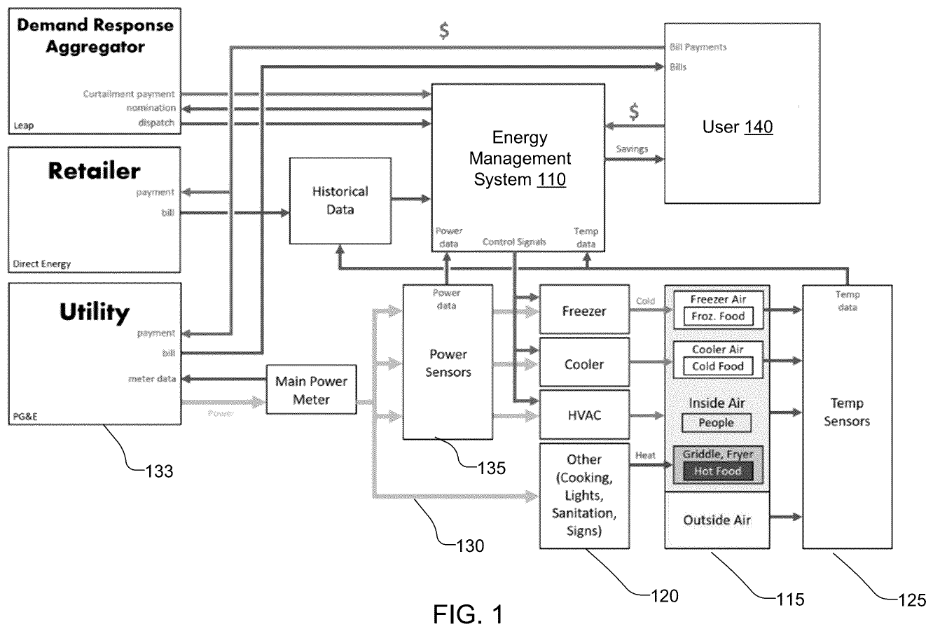

FIG. 1 shows an overall system environment in which an energy management system operates, according to an embodiment. Other embodiments may have more or fewer components. FIG. 1 shows that electrical power comes from utility companies or energy retailers (like direct energy or community choice aggregator). This electric power is used to run the freezer, cooler, HVAC system, and other equipment-like lights, sanitation, and signs. The utility and the retailer provide the electrical power to the facility that is responsible for incurring the costs of the energy.

The energy management system 110 manages energy consumed by facility 115. The facility refers to the buildings and infrastructure used by an establishment where business activities take place. Examples of facilities include industries, restaurants, hotels, and so on. A facility may also be referred to herein as an establishment. The facility 115 may have one or more refrigeration equipment, one or more lighting systems, one of more HVAC (heating, ventilation, and air conditioning) equipment, cooking equipment, and so on. The energy management system 110 manages energy consumption of such facilities. Large facilities may have significant energy consumption due to various types of equipment being operated. The energy management system 110 manages and controls energy consumption of such facilities to reduce the overall cost of energy for such establishments. According to an embodiment, the energy management system 110 turns various equipment of a facility on or off in a controlled manner, thereby reducing their energy consumption and energy costs. The facility receives power vis power lines 130 coming from utility company 133. The energy management system 110 also receives signals indicating the power consumption of the facility 115 using power sensors 135. The energy management system 110 communicates with the user to provide information describing the savings in terms of energy consumption.

The energy management system 110 sends controls signals to various types of equipment 120 of the facility such as refrigeration equipment, HVAC equipment, and so on. The control signals may turn the equipment on or off at appropriate time to conserve energy. The energy management system 110 uses temperature sensors 125 to measure temperature of various equipment or areas within the facility to receive feedback on the control process.

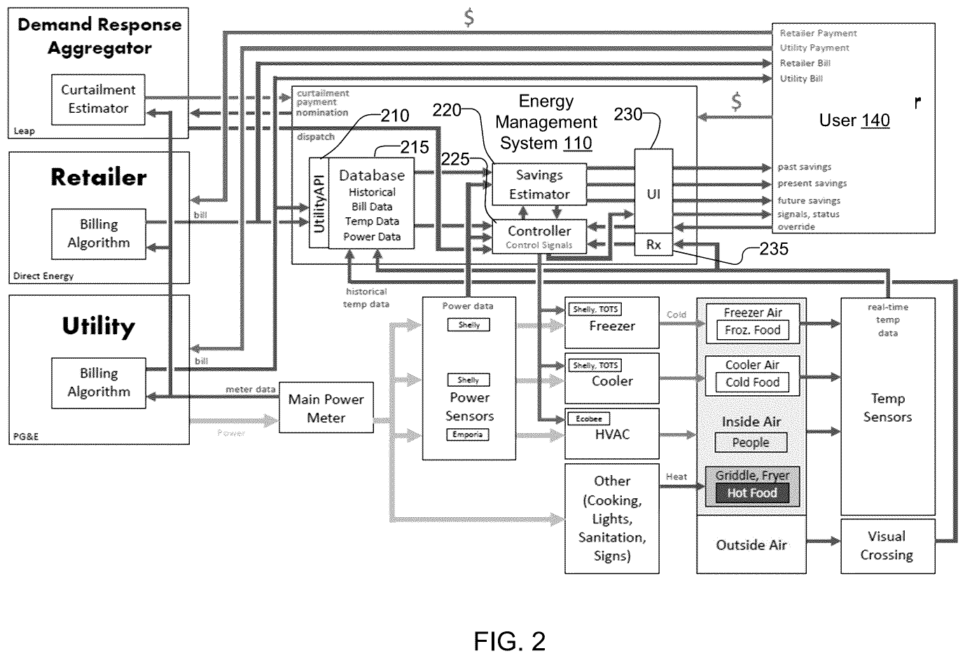

FIG. 2 illustrates the architecture of the energy management system in the context of the system environment, according to an embodiment. The energy management system 110 comprises a utility API 210 (application programing interface), a database 215, a savings estimator 220, a controller 225, a user interface 230, and a receiver 235. The energy management system 110 sends control signals generated by the controller 225. The controller 225 of the energy management system 110 receives temperature data through the receiver 235. The database 215 stores information describing past (historical) energy consumption, for example, bills, temperature data, power data, and so on. The energy management system 110 uses the historical data to be able to predict energy consumption in various contexts. The energy management system 110 may use the utility API 210 to get historical data or current power consumption or other details from the utility company 133. The savings estimator 220 monitors and estimates savings in energy consumption of the facility 115 as a result of control signals. The savings estimator 220 may monitor the savings in real time or periodically, for example, at the end of the month to measure the aggregate savings over a time period. The user interface 230 displays information describing the energy consumption and savings to the user 140. The energy management system 110 provides an override capability that allows the user to override the signals generated by the controller 225, for example, if the facility needs to maintain a particular temperature for certain reason. The energy management system 110 uses a simulator to simulate the characteristics of various types of equipment within a facility. The simulators allow the energy management system 110 to test and try out various strategies for improving energy consumption of appliances or equipment in a facility. The simulator simulates the energy consumption behavior of the entire facility including all the equipments and also determines the savings in power and costs (or utility bills) based on the strategies in a time dynamic manner as these values change over time. The energy management system 110 may also be referred to as Thermaº™ Cooling Intelligence Platform (TCIP).

For most facilities such as restaurant, that's just the cost of doing business. And those bills are not just expensive-they can be complicated and confusing. There are several complications with the electricity/energy charges, for example, peak and off-peak energy charges, max peak and max demand charges, generation credits and so on. Users do not have time or expertise to understand these details and are unable to find ways to reduce their consumption and cost of electricity.

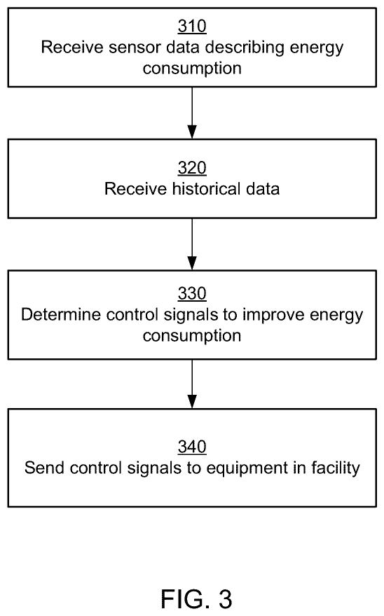

FIG. 3 is a flowchart illustrating the overall process of the energy management system, according to an embodiment. The energy management system 110 receives 310 sensor data describing energy consumption of a facility 115. The sensor data may be collected by sensors 125 and provided to the energy management system 110. The energy management system 110 also receives 320 historical data, for example, past trends of energy consumption, cost information, and so on from the utility company 133 or any other source of information, for example, information stored locally in the database 215. The energy management system 110 determines 330 values of control signals for improving the energy consumption. The energy management system 110 may execute the simulator to predict effect of certain strategies and finalize on control signal values. The energy management system 110 sends 340 the control signals to various equipment of the facility to adjust their energy consumption.

The overall process controls the energy consumption of equipment based on criteria such as maintaining temperature of equipment so that it is in a range that is suitable for the use. For example, the energy consumption of the air conditioner or heating equipment (e.g., HVAC equipment) is performed in a manner that the temperature of the rooms controlled by the air conditioner remains in a range that is comfortable to the people in the room, for example, visitors of a hotel or restaurant. As another example, the energy consumption of refrigeration equipment is performed in a manner that the temperature of the refrigerator remains in a range that keeps the food and other perishables fresh. However, the energy consumption is performed subject to these constraints to optimize a cost metric. The cost metric is determined based on various factors including the total energy consumption within an interval such as a month and peak energy consumption within smaller periodic intervals, for example, intervals of 15 minute each. Accordingly, the energy management system 110 performs a constrained optimization of the energy consumption of a facility, where the constraints are specific to each equipment (to keep the equipment operating in certain manner) and the optimization of a cost metric based on the energy consumption. The system implements the constrained optimization using a feedback control system that receives sensor data from sensors such as temperature sensors, humidity sensors, etc. to monitor the operation of various equipment and generates a control signal based on the feedback.

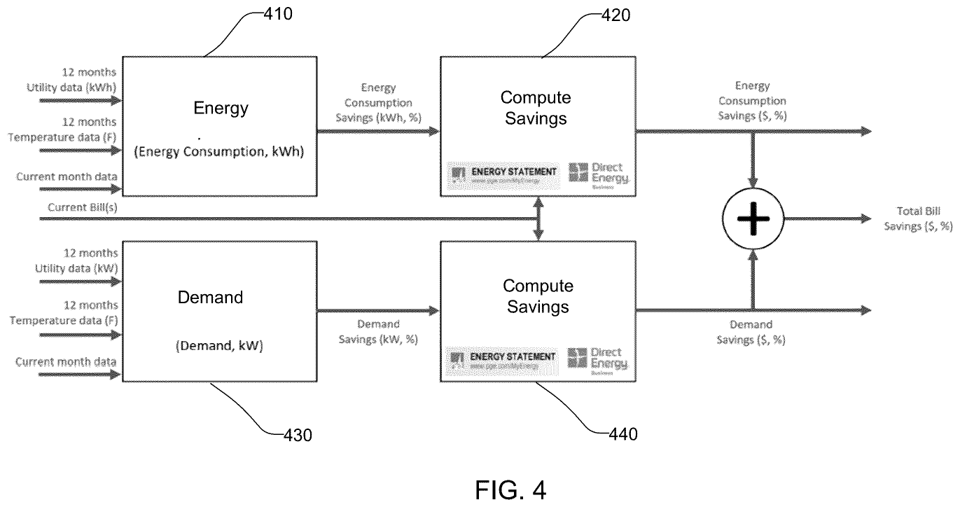

FIG. 4 illustrates the architecture of a savings estimator component of the energy management system, according to an embodiment. The savings estimator 220 measures savings in energy consumption based on techniques disclosed herein. IPMVP ins an industry standard for determining savings using energy consumption and refers to International Performance Measurement Verification Protocol. The energy management system 110 uses the standard techniques to measure savings. The energy management system 110 uses one of the options of IPVMP, i.e., option C. Any other techniques for measuring savings in energy consumption may be used. The energy management system 110 tracks energy consumption over time, for example, for every month. The savings estimator 220 determines energy consumption in kilowatt hours 410 and demand in kilo watts 430 based on techniques such IPMVP protocol and computes savings 420 and 440 respectively based on each. According to an embodiment, the savings 420 and 440 are determined based on various factors including time of day, season, the peak value of the power consumed, and so on. According to an embodiment, the energy savings are converted to a monitory amount that is saved. The cost of energy depends on the total energy that is consumed by the facility. The cost of energy also may depend on the demand that represents the maximum value of energy consumed at any point in a time period, for example, the highest energy consumed during a month. The power source needs to provide capacity to deliver the peak energy and therefore the total cost of energy for a period depends on the maximum energy that was used. The energy used is computer in small time intervals, for example, 15 minute time intervals. Accordingly, the maximum energy consumed by the facility during a 15 minute time interval affects the total cost of energy for a longer time interval, for example, a month.

According to an embodiment, techniques used by the controller 225 are influenced by the results of the savings estimator 220. For example, the results of the savings estimator 220 may determine that the controller 225 is adjusted to increase savings by reducing energy consumption aggressively, for example, by reducing energy consumption by a larger factor. Alternatively, the results of the savings estimator 220 may determine that the controller 225 may be adjusted to decrease savings by reducing energy consumption less aggressively, for example, by decreasing the factor by which energy consumption is reduced. The feedback between the savings estimator 220 and the controller 225 may be manual, for example, involving expert users or may be automatic.

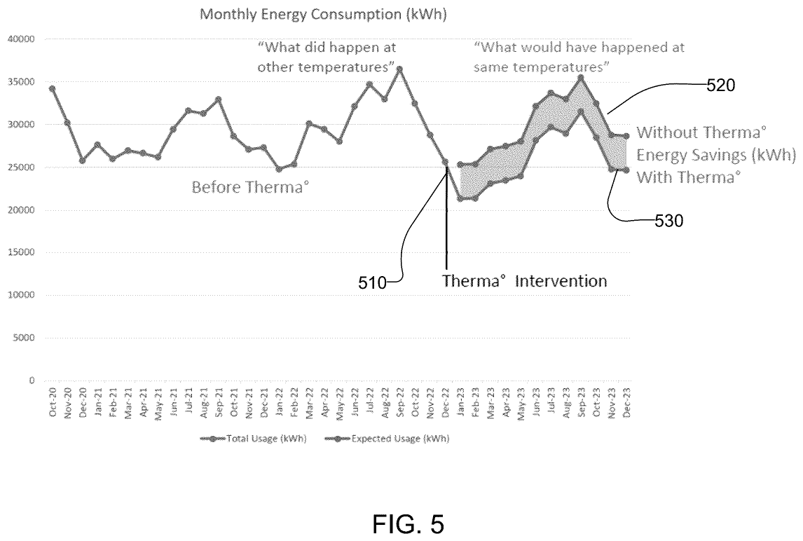

FIG. 5 illustrates the computation of savings in energy consumption, according to an embodiment. According to an embodiment, the savings estimator 220 adjust the energy measurements for various factors to determine savings, for example, by adjusting for seasonal variations during the same time period. The time point 510 represents the time when the energy management system 110 was installed in a facility to improve energy consumption of the facility. The time period before 510 represents the time when the energy management system 110 was not being used for saving in energy consumption and the time period after 510 represents the time when the energy management system 110 was being used to save on energy consumption of the facility 115. According to an embodiment, the savings estimator 220 adjust the energy measurements for various factors to determine savings, for example, by adjusting for seasonal variations during the same time period. For example, the savings estimator 220 estimates the energy consumption 520 based on a prediction model that uses factor such as historical data for similar conditions such as environmental factors (e.g., weather conditions), time of year, and so on. According to an embodiment, the savings estimator 220 predicts the energy consumption 520 without the energy saving techniques disclosed herein (for example, using a regression-based model) and compares them with energy consumption 530 when the energy management system 110 is used for saving on energy consumption.

For example, the savings estimator 220 estimates the energy consumption based on a prediction model that uses factor such as historical data for similar conditions such as environmental factors, time of year, and so on. According to an embodiment, the savings estimator 220 predicts the energy consumption without the energy saving techniques disclosed herein and compares them with energy consumption when the techniques disclosed are used.

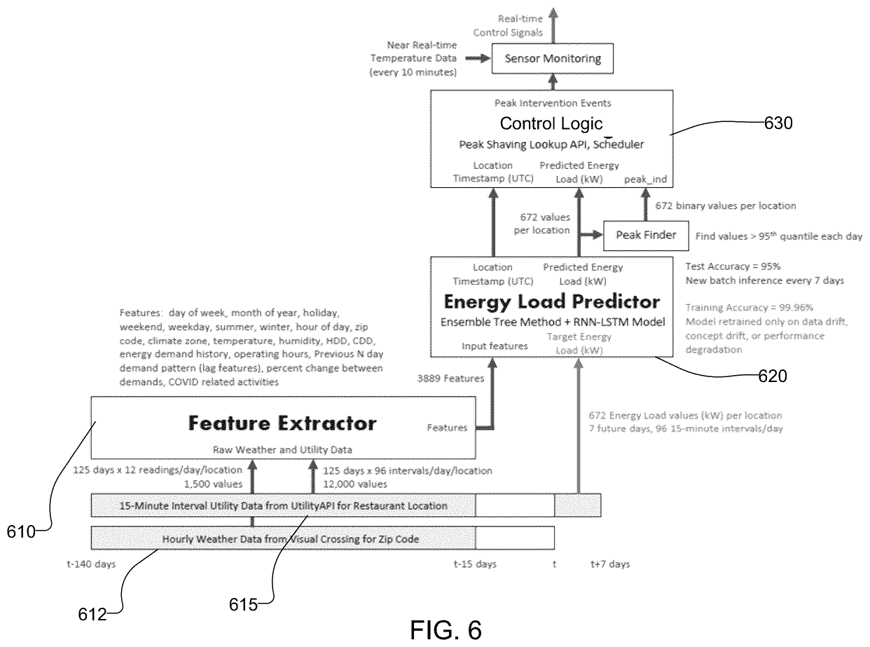

FIG. 6 illustrates a peak shaving system that determines the control signals for controlling energy consumption of a facility, according to an embodiment. According to an embodiment, the peak shaving system predicts the time of peak energy consumption of the facility and turns off some of the equipment to reduce the peak energy consumption. The feature extractor 610 of the model extract features such as day of the week, month of the year, whether day is a weekend or weekday, hour of day, location, energy demand history, operating hours, 15 minute interval utility data 615 and hourly weather data 612. The features are provided as input to the energy load predictor 620 that makes a prediction of the time of peak energy consumption and provides the data to the control logic 630 that generates the sensor data to reduce the energy consumption.

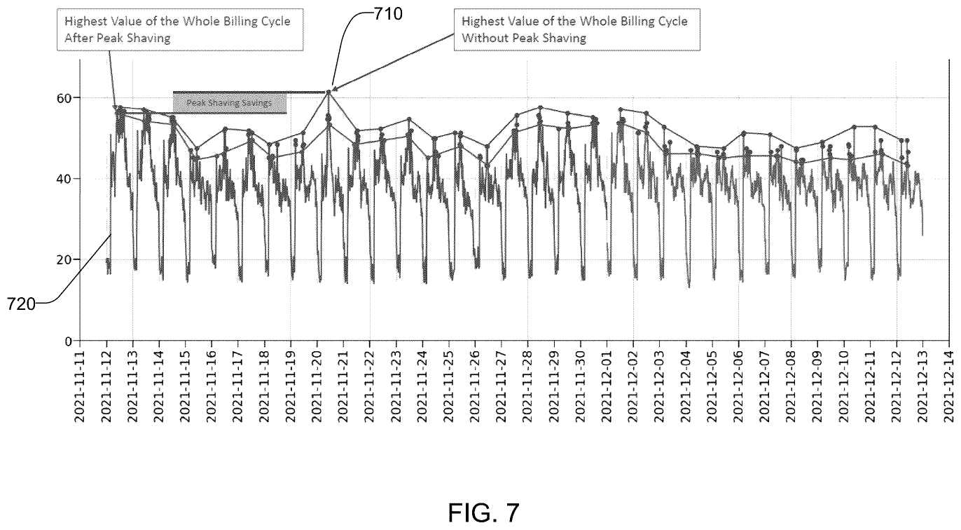

FIG. 7 illustrates how peak shaving of energy consumption improves the cost metrics of energy consumption, according to an embodiment. FIG. 7 shows the energy consumption over a time interval, for example, a month. As shown in FIG. 7, every day the energy consumption is low during certain parts of the day, for example, over night when the equipment in the facility is not used and the energy consumption is high during some parts when the equipment in the facility is being actively used. On certain days the peaks are higher than other days. The highest peak is 710. The highest peak during the entire month determines the value of the cost metric. Other factors that determine the cost metric include the area under the curve 720 that represents the total energy consumption during the time interval, for example, the entire month. The peak energy consumption may get increased for a very short time interval, e.g., a 15 minute interval during the entire month and may impact the cost metric for the entire month. If the peak energy consumption 710 can be reduced by certain percentage, the entire const metric is reduced by significant amount. Therefore, the energy management system 110 aims to predict the peak energy consumption before it occurs so that the energy management system 110 can turn off at least some of the equipment to reduce the peak value 710. According to an embodiment, the energy management system 110 predicts the top K (e.g., K=5) peaks during the day and reduce the energy consumption before the system reaches those predicted peaks.

According to another embodiment, the system predicts the peak values at a point in time of the day based on corresponding values of the past few days, for example, past 5 days.

The controller processes are based on parameters used to perform optimization of energy consumed by a facility. The controller process needs to be optimized over time to improve energy consumption of the facility. However effects of implementing certain optimization techniques may not be observed in practice for long periods of time, for example, several months or years. The system uses a simulator of the over all system environment to test and evaluate the optimization techniques used by the controller for optimizing the cost metric or energy consumption metric for a facility. The simulator makes it practical to try out various optimization techniques in reasonable time and improves the efficiency of the optimization process. According to an embodiment, the simulator is executed to evaluate a particular set of parameters of the energy optimization process. The simulator may be executed to simulate a long period of time, for example, several years but would provide the results in minutes or seconds. The simulator may be executed to simulate weather conditions of various places, for example, different cities with varying weather patterns. The parameters of the energy optimization process are adjusted and then the simulator executed again. This process is repeated multiple times until the energy optimization process has parameters that return almost optimal results or results that do not improve further upon modification of parameters.

The simulator provides several technical improvements over a technique that tries the energy optimization process using actual facility. The simulator allows fast improvements to techniques that perform energy having, energy shifting, or other ways of optimizing energy consumption. The simulator models realistic equipments such as HVAC (Heating, Ventilation, and Air Conditioning) equipment at various types of facilities and in different locations. This allows an installation to be evaluated via simulation at a site before actually installing the equipment. The simulator offers various ways to control the processes and repeatedly test them under similar conditions while varying certain parameters, for example, varying the weather temperature while keeping other factors constant. Also evaluating the system by simulation is cost effective compared to having an actual installation and then making modifications to the installation. The simulator allows testing the system in situations that are undesirable or risky, for example, trying high temperatures that may not be realistic in a real facility. Also, if an optimization technique being tested is faulty, the system may perform dangerously by putting the facility at risk. Testing these situations via simulation avoids putting real facilities at risk. The simulator also allows determining energy savings with or without a particular energy optimization technique in place. The simulator can be executed multiple times with or without the energy optimization technique to evaluate the energy consumption. This is not possible in a practical system since it may not be possible to reproduce identical situations repeatedly. The simulator allows the system to be tried in alternate universes with varying parameters which is not possible in a realistic system. The simulator can simulate long periods such as several decades in matter of hours which is practically impossible.

Accordingly, the simulator has several applications, for example, to calibrate the energy optimization processes, to perform controlled simulation of the system environment, to perform savings estimation with and without certain optimization technique, and so on. Various questions can be answered using the simulator, for example, (1) How much Bill Savings can the system get from Peak Shaving? (2) How much should the system stagger the Resume Times in Peak Shaving? (3) How many HVAC Units should the system turn off in a Peak Shaving Intervention? (4) How much Energy (kWh) Savings can the system get from HVAC ASHRAE (American Society of Heating, Refrigerating and Air-Conditioning Engineers) Settings? (5) How much Bill Savings (monetary savings) can the system get from HVAC ASHRAE Settings? (6) How much Bill Savings (monetary savings) does the system lose for every 1° F. in Baseline Cooling Setpoint? (7) How much user discomfort happens with specific optimization techniques (for example, by turning off air conditioning equipment)?

The simulator simulates a weather pattern over a time period, for example, over an entire year or over two years. The simulator simulates the outside temperature at any particular time. The system generates the data based on historical data. The system generates random numbers that are similar to realistic temperature variations over time. The system may generate weather for a set of locations where the system may have to be installed. According to an embodiment, the simulation of the weather component automatically retrieves historical weather data for a location and uses the historical weather data to train the model to predict weather data for that location for any future time period.

The simulator receives as input certain set points that are selected for the facility, for example, opening hours, closing hours, the range of temperatures that the facility would like to maintain, for example, a range between a cooling set point and a heating set point. The simulator simulates the energy consumption of each simulated equipment of the facility. The simulator solves a set of differential equations for determine the energy consumption of the facility.

### Computing Machine Architecture

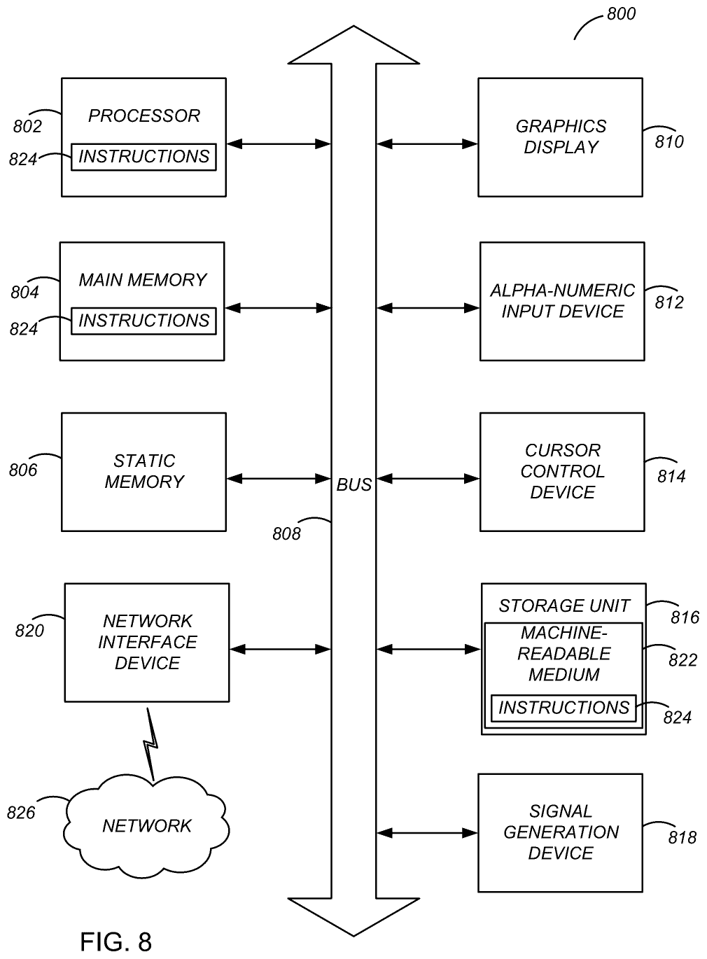

FIG. 8 is a block diagram illustrating components of an example machine able to read instructions from a machine-readable medium and execute them in a processor (or controller). Specifically, FIG. 8 shows a diagrammatic representation of a machine in the example form of a computer system 800 within which instructions 824 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes a processor 802 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 804, and a static memory 806, which are configured to communicate with each other via a bus 808. The computer system 800 may further include graphics display unit 810 (e.g., a plasma display panel (PDP), a liquid crystal display (LCD), a projector, or a cathode ray tube (CRT)). The computer system 800 may also include alphanumeric input device 812 (e.g., a keyboard), a cursor control device 814 (e.g., a mouse, a trackball, a joystick, a motion sensor, or other pointing instrument), a storage unit 816, a signal generation device 818 (e.g., a speaker), and a network interface device 820, which also are configured to communicate via the bus 808.

The storage unit 816 includes a machine-readable medium 822 on which is stored instructions 824 (e.g., software) embodying any one or more of the methodologies or functions described herein. The instructions 824 (e.g., software) may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 (e.g., software) may be transmitted or received over a network 826 via the network interface device 820.

While machine-readable medium 822 is shown in an example embodiment to be a single medium, the term “machine-readable medium” should be taken to include a single medium or multiple media (e.g., a centralized or distributed database, or associated caches and servers) able to store instructions (e.g., instructions 824). The term “machine-readable medium” shall also be taken to include any medium that is capable of storing instructions (e.g., instructions 824) for execution by the machine and that cause the machine to perform any one or more of the methodologies disclosed herein. The term “machine-readable medium” includes, but not be limited to, data repositories in the form of solid-state memories, optical media, and magnetic media.

### Alternative Embodiments

It is to be understood that the figures and descriptions of the present invention have been simplified to illustrate elements that are relevant for a clear understanding of the present invention, while eliminating, for the purpose of clarity, many other elements found in a typical system. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for generating reports based on instrumented software through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method comprising:
monitoring equipment of a facility, the facility comprising one or more equipments, wherein monitoring equipment of the facility comprises receiving sensor data generated by sensors of the one or more equipments of the facility, wherein at least one of the one or more equipments adjusts temperature within the facility;
determining values of control signals for controlling one or more equipments of the facility, wherein the control signals are generated to operate each equipment within one or more constraints, wherein the values of the control signals are determined to optimize an energy consumption metric for the facility;
for each equipment, sending control signals having a value determined for the equipment to control the equipment, wherein the control signals cause the equipment to operate within the one or more constraints associated with the equipment; and
determining a value of the energy consumption metric for the facility and sending to a user associated with the facility.

2. The computer-implemented method of claim 1, an equipment of the facility is a refrigeration equipment, wherein the one or more constraints of the equipment require the temperature inside the refrigeration equipment to be maintained within a range.

3. The computer-implemented method of claim 1, an equipment of the facility is an air conditioning equipment, wherein the one or more constraints of the air conditioning equipment require the temperature of a room of the facility cooled by the air conditioning equipment to be maintained within a range.

4. The computer-implemented method of claim 3, wherein the one or more constraints of the air conditioning equipment require a humidity of the room of the facility to be maintained within a range.

5. The computer-implemented method of claim 1, an equipment of the facility is a heating equipment, wherein the one or more constraints of the heating equipment require a temperature of a room of the facility heated by the air conditioning equipment to be maintained within a range.

6. The computer-implemented method of claim 1, wherein determining the values of the control signals to optimize an energy consumption metric for the facility comprises:
predicting a time of peak energy consumption of the facility; and
reducing energy consumed by one or more equipments at the time predicted for peak energy consumption of the facility.

7. The computer-implemented method of claim 6, wherein reducing energy consumed by an equipment comprises shutting off the equipment for a time interval during which the time predicted for peak energy consumption of the facility occurs.

8. The computer-implemented method of claim 6, wherein the equipment is an air conditioner and reducing the energy consumed by the air conditioner comprises raising the temperature of a room cooled by the air conditioner to a higher value permitted by a constraint associated with the air conditioner.

9. The computer-implemented method of claim 6, wherein the equipment is a refrigeration equipment and reducing the energy consumed by the equipment comprises raising the temperature of the refrigeration equipment to a higher value permitted by a constraint associated with the refrigeration equipment.

10. The computer-implemented method of claim 6, wherein the equipment is a heating equipment and reducing energy consumed by the heating equipment comprises reducing the temperature of a room heated by the heating equipment to a lower value permitted by a constraint associated with the heating equipment.

11. A non-transitory computer-readable storage medium storing computer program instructions executable by one or more computer processors to perform operations comprising:
monitoring equipment of a facility, the facility comprising one or more equipments, wherein monitoring equipment of the facility comprises receiving sensor data generated by sensors of the one or more equipments of the facility, wherein at least one of the one or more equipments adjusts temperature within the facility;
determining values of control signals for controlling one or more equipments of the facility, wherein the control signals are generated to operate each equipment within one or more constraints, wherein the values of the control signals are determined to optimize an energy consumption metric for the facility;
for each equipment, sending control signals having a value determined for the equipment to control the equipment, wherein the control signals cause the equipment to operate within the one or more constraints associated with the equipment; and
determining a value of the energy consumption metric for the facility and sending to a user associated with the facility.

12. The non-transitory computer-readable storage medium of claim 11, an equipment of the facility is a refrigeration equipment, wherein the one or more constraints of the equipment require the temperature inside the refrigeration equipment to be maintained within a range.

13. The non-transitory computer-readable storage medium of claim 11, an equipment of the facility is an air conditioning equipment, wherein the one or more constraints of the air conditioning equipment require the temperature of a room of the facility cooled by the air conditioning equipment to be maintained within a range.

14. The non-transitory computer-readable storage medium of claim 13, wherein the one or more constraints of the air conditioning equipment require a humidity of the room of the facility to be maintained within a range.

15. The non-transitory computer-readable storage medium of claim 11, an equipment of the facility is a heating equipment, wherein the one or more constraints of the heating equipment require a temperature of a room of the facility heated by the air conditioning equipment to be maintained within a range.

16. The non-transitory computer-readable storage medium of claim 11, wherein determining the values of the control signals to optimize an energy consumption metric for the facility comprises:
predicting a time of peak energy consumption of the facility; and
reducing energy consumed by one or more equipments at the time predicted for peak energy consumption of the facility.

17. The non-transitory computer-readable storage medium of claim 16, wherein the equipment is an air conditioner and reducing the energy consumed by the air conditioner comprises raising the temperature of a room cooled by the air conditioner to a higher value permitted by a constraint associated with the air conditioner.

18. The non-transitory computer-readable storage medium of claim 16, wherein the equipment is a heating equipment and reducing energy consumed by the heating equipment comprises reducing the temperature of a room heated by the heating equipment to a lower value permitted by a constraint associated with the heating equipment.

19. A computer system comprising:
one or more computer processors; and
a non-transitory computer-readable storage medium storing computer program instructions executable by the one or more computer processors to perform operations comprising:
monitoring equipment of a facility, the facility comprising one or more equipments, wherein monitoring equipment of the facility comprises receiving sensor data generated by sensors of the one or more equipments of the facility, wherein at least one of the one or more equipments adjusts temperature within the facility;
determining values of control signals for controlling one or more equipments of the facility, wherein the control signals are generated to operate each equipment within one or more constraints, wherein the values of the control signals are determined to optimize an energy consumption metric for the facility;
for each equipment, sending control signals having a value determined for the equipment to control the equipment, wherein the control signals cause the equipment to operate within the one or more constraints associated with the equipment; and
determining a value of the energy consumption metric for the facility and sending to a user associated with the facility.

20. The computer system of claim 19, an equipment wherein determining the values of the control signals to optimize an energy consumption metric for the facility comprises:
predicting a time of peak energy consumption of the facility; and
reducing energy consumed by one or more equipments at the time predicted for peak energy consumption of the facility.
